(19) United States
(12) Patent Application Publication
(10) Pub. No.: US 2012/0197809 A1
(43) Pub. Date: Aug. 2, 2012

(54) Method and System for Automated Construction of Project Teams

(76) Inventors: Charles Calvin Earl, Decatur, GA (US); Kaakpema Yelpaala, Denver, CO (US); Travis James Good, Denver, CO (US); Amos Yancy Johnson, JR., Austell, GA (US)

(21) Appl. No.: 13/017,005

(22) Filed: Jan. 29, 2011

(51) Int. Cl. G06Q 10/00; G06F 17/30

(52) U.S. Cl. 705/301; 707/794; 707/755; 707/E17.009; 707/E17.045

(57) ABSTRACT

A method embodied as a web application that enables the automated construction of project teams from profiles contained in data sources accessible through the World Wide Web. The data sources may include social networks, blogs, web pages, and postings on online discussion forums. The locations of these data sources are supplied by a system administrator (during configuration and maintenance) and by registered users of the web application. The web application allows the system administrator to create a set of templates describing the kinds of roles and skills required by the users of the web application. The web application identifies potential team members referenced in the information sources and constructs a semantic network describing the skill sets and team suitability of those potential team members. The web application allows a registered user to enter the roles and capabilities required for a project team they wish to create. Once the user has entered a description of their desired project team, the application automatically constructs candidate teams by analyzing the semantic network to identify appropriate candidate teams given constraints on roles and skills. Four methods for identifying teams from the semantic network are provided. The system then provides the user with a set of recommended team members. In an iterative process, the user adjusts constraints on the team member capabilities until a satisfactory team is identified. The web application allows the user to negotiate compensation with the selected team, and provides a web-based collaboration page that the user and team may use for communication and coordination.

### STATEMENT REGARDING FEDERALLY FUNDED RESEARCH

The research performed to develop the prototype of this system was funded through the NSF Phase I SBIR grant NSF 0944407

### CROSS REFERENCE TO RELATED APPLICATIONS

None.

### BACKGROUND

Interviews of film and video professionals conducted by the inventors reveal widespread interest in the ability to form virtual; limited-duration project teams to perform the work associated with specific production projects. This ephemeral teaming is echoed by the nature of video production work, which is becoming increasingly decentralized, enabled by the spectrum of communication technologies available. Independent filmmakers, postproduction companies, and broadcast news organizations are increasingly turning to virtual collaboration and outsourcing to construct virtual teams for production. The construction of these teams happens through word of mouth and is largely ad hoc. Virtual teaming for film and video is inadequately addressed by current virtual freelance marketplace platforms, the largest of which are Elance (www.elance.com) and oDesk (www.odesk.com). We believe that these teams can be constructed using profile information that can be provided through online communities frequently used by film professionals. We believe that the core technology can be widely applied to identify virtual teams in other domains.

Outside of the sphere of professional film creation, there is a tremendous opportunity to provide non-professionals with the ability to secure professional talent to provide as-needed support for film production, editing, and distribution. Therefore, both professionals and non-professionals alike could benefit from the ability to rapidly assemble the talent needed to pursue specific video production projects. While these capabilities are most apparent in film production, the need to rapidly assemble virtual teams for specific limited tasks has wide applicability: the same general capabilities could be used by municipal governments trying to assemble a team of software developers to support development of a database system or by relief agencies needing to assemble teams for disaster response efforts.

The process of virtual team construction is therefore one in which an individual wishes to form a team to accomplish a production task, describes the desired product, optionally describes the skills necessary in team members, and then submits this description to a system which then returns dossier of individuals recommended for the team. In the film production community, professionals are by and large participants in rich virtual networks consisting of video sharing sites (e.g. Vimeo, shortfilmfestivals, imdb, etc.) online social networks (e.g. twitter, youtube), product oriented websites (e.g. for Adobe products), not to mention social networks developed around film schools and professional organizations. Our system leverages these information sources to accelerate the construction of virtual teams.

LinkedIn.com is the social network which is most attuned to business processes and networking. While LinkedIn provides recruiting and job search tools, it provides no facilities to create and manage virtual teams; and the recruiting tools do not have extensive domain knowledge to support search and collaboration nor do they provide the ability to leverage information contained in other information sources. Odesk.com and elance.com are the major job contracting software platforms. Neither Odesk.com nor elance.com are capable of incorporating social network or specific information into the rating process, nor do they support the collaboration of teams once they are formed.

The patent “Method for online game matchmaking using play style information”, U.S. Pat. No. 7,614,955 is similar in that it describes a system for identifying people to play together in an online gaming system. The methods for identifying people for the teams are different than those described here and the teams are limited to the activity of online game play. The patent “Cohesive Team Selection Based on a Social Network Model”, Ser. No. 11/560,733 describes a system for identifying members of an organization that can work together based upon email communication between members. This system differs significantly from ours in that: 1) team members must know each other; 2) the members are to be within a single organization; 3) there is no assessment of skill for a particular task.

Other published work relating to this work includes:
Bouguet, J. Y. & others, 1999, Pyramidal implementation of the Lucas Kanade feature tracker description of the algorithm, Intel Corporation, Microprocessor Research Labs, OpenCV Documents.
Frost & Sullivan. World Video Non-Linear Editing Market. 2009.
Fredman, M. L. & Tarjan, R. E. (1987). Fibonacci heaps and their uses in improved network optimization algorithms. Journal of the ACM (JACM), 34(3), 596-615.
Goel, A., Kapralov, M., & Khanna, S. (2010). Perfect matchings in O(n \ log n) time in regular bipartite graphs.
Huang, T. Y., Huang, P. & Wang, P. J., 2010, Could Skype Be More Satisfying? A QoE-Centric Study of the FEC Mechanism in an Internet-Scale VoIP System, IEEE Network, p. 3.
Renambot, L., Jeong, B. & Leigh, J., 2007, Real-Time Compression For High-Resolution Content, Proceedings of the Access Grid Retreat.
Sen, S., Vig, J. & Riedl, J., 2009, Proceedings of the 18th international conference on World wide web, Tagommenders: connecting users to items through tags. pp. 671-80.
Stoyen, Alex and Werth, Rachel. MediaCloud: Distributed Computing System for Online Rich Media Creation. Dawnbreaker Stoplight Assessment. June 2010.
Swain, M. J. & Ballard, D. H. (1991). Color indexing. International Journal of Computer Vision, 7(1), 11-32.
Zhang, Nandi, Riedi & Druschel, 2010, Measurement-based Analysis, Modeling, and Synthesis of the Internet Delay Space, IEEE/ACM Transactions on Networking.
Pearce, J. P. & Tambe, M., 2007, Proceedings of IJCAI, Quality guarantees on k-optimal solutions for distributed constraint optimization problems. pp. 1446-51.

### BRIEF SUMMARY OF THE INVENTION

We provide a computer program embodied as a web application that enables the automated construction of project teams from profiles assembled from Internet data sources. While online social networks comprise a major data source, information to construct teams is also to be found in online discussion forums, blogs, and professional websites. The system begins with a set of templates for the kinds of roles and skills required by the users of the system. This information is supplied by an administrator and can be added to by a user of the system. Using said data sources—again provided initially by an administrator and extended by registered users—the application extracts potential team members from those sources and determines their level of expertise with respect to the roles defined in the templates. An end user of the system provides the application with a set of roles and capabilities required of the project team, and the application provides the user with a set of recommendations for team members. In an iterative process, the user may adjust constraints on the member capabilities until a satisfactory team is identified. The application then creates a web page through which the tasks assigned the team can be monitored and managed.

The advantages of our method for automated construction of project teams over LinkedIn are thus: 1) virtual team formation is supported through our team construction method whereas it is not through LinkedIn; 2) integration of information from other information sources is supported by the team construction method, enabling it to provide a wider range of options than available in LinkedIn recruitment; 3) domain specific information available in the team construction method that will allow the it to suggest teams that more representative of the way in which teams in a particular domain are formed.

The major advantages of the team construction method over oDesk.com and elance.com platforms are: 1) the described team construction method supports the work-centric formation of virtual teams in which specific roles in a task are identified and assigned to the most capable individual, whereas Odesk.com and elance.com are more geared to a contract-specific bid process in which the user identifies discrete tasks to perform on an individual basis forcing the user to build and identify teams themselves; 2) the team construction method allows the import of external social network information for identifying and recruiting professionals to work in the teams, leveraging existing social and professional networks; whereas Odesk.com and elance.com platforms are limited in their use of subscribers to their sites.

### FIGURES

FIG. 1 explains how the semantic network describing the skills of potential project team members is constructed from information sources available on the Internet and elsewhere.

FIG. 2 describes how virtual teams are constructed using the relationships that are inferred from the said semantic network of potential project team members.

FIG. 3 describes the flow of information between disparate information sources and describes how multiple capability graphs can be merged and used to identify and recommend members of the created team.

FIG. 4 describes semantic relationships between entities that are used to determine the ranking of an individual with respect to team suitability for the video production domain.

FIG. 5 describes semantic relationships relating to individual skill sets that are relevant for the video production domain.

FIG. 6 depicts semantic relationships that used to perform the extraction of semantic network from the Vimeo video sharing website.

FIG. 7 depicts semantic network of capabilities that were extracted using the text processing method from the Vimeo video sharing website for a subset of users.

FIG. 8 is a table that includes performance results for the prototype implementation of our method for automated construction of project teams. The results show that the said method assembles teams in acceptable time and that the performance scales as the size of the dataset increases.

FIG. 9 shows team recommendations produced by the method described, presented in a web page interface.

### DETAILED DESCRIPTION

The core technology of virtual team creation is an engine that creates an extended graph of individuals and their interests, capabilities, and availabilities from social network data. This data is stored as a semantic network called the Community Capability Graph (CCG). In the CCG semantic network, vertices correspond to individuals, and edges correspond to relations and community attributes relevant to their expertise. Let us define the individual that is creating or managing the team as the team creator. The team creator provides either a description of the task that they are seeking help with, a description of the kinds of roles that they need to fill, or the explicit skills they are seeking. This description is used to create a set of team roles. These team roles constrain a search on the CCG; and the result of this search consists of suggested assignments of team roles to individuals retrieved from the CCG.

The primary source of data for the CCG is member profiles. Here, a member profile will include information about previous and on-going projects, interests, and skills. We began our testing of the platform by using profile attributes based on those used in popular video-sharing sites. In the broader sense, CCG must encompass information that is contained on relevant blogs, discussion lists, and other web communities that specifically support the film production community. These are relevant sources of information for the video production domain, but this can be transferred to other domains as well. Extending CCG beyond profile information also allows the analysis to construct a broader profile of team members. Sources include open sourced blogs that can be identified and analyzed by web crawling and partner arrangements, and individual users, who can choose to share networks between platforms in order to accelerate team construction.

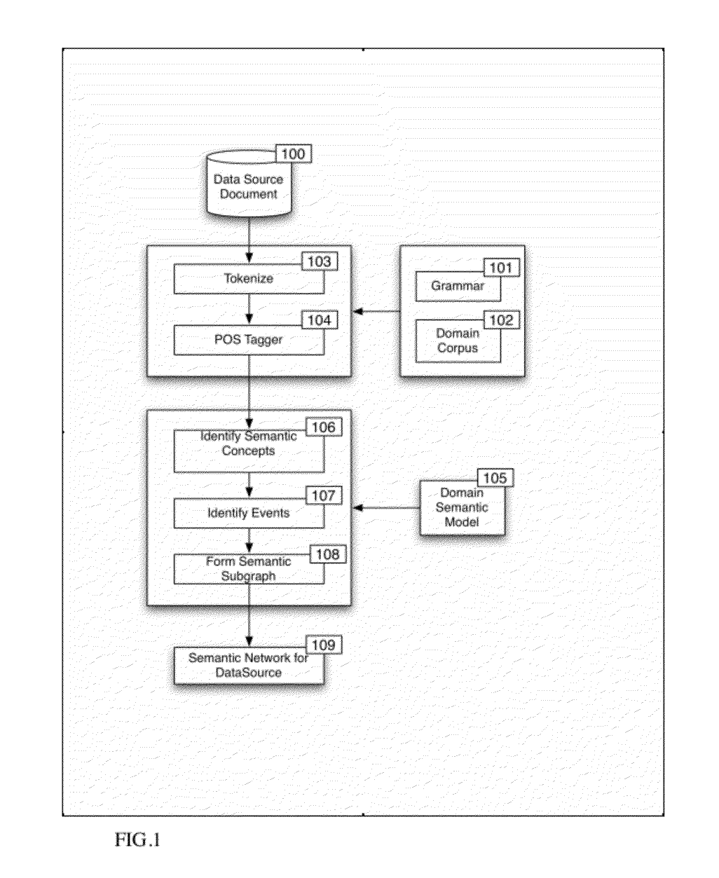

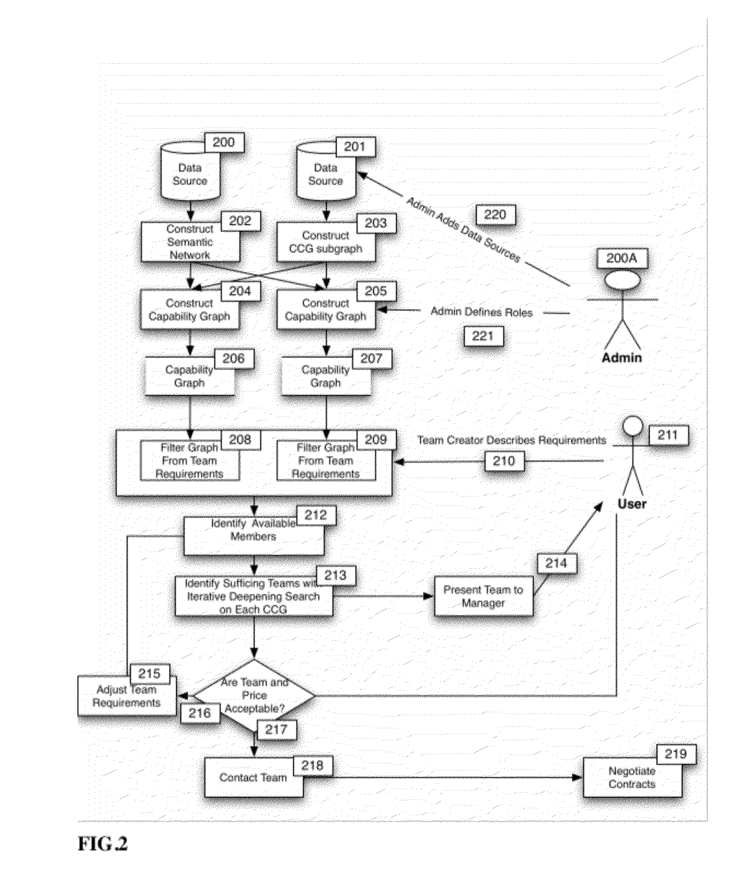

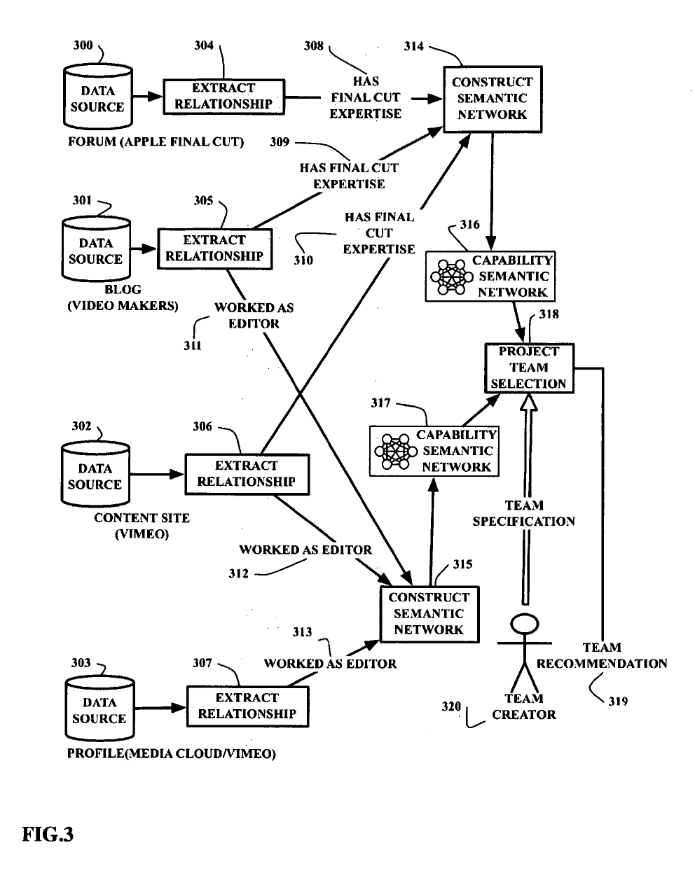

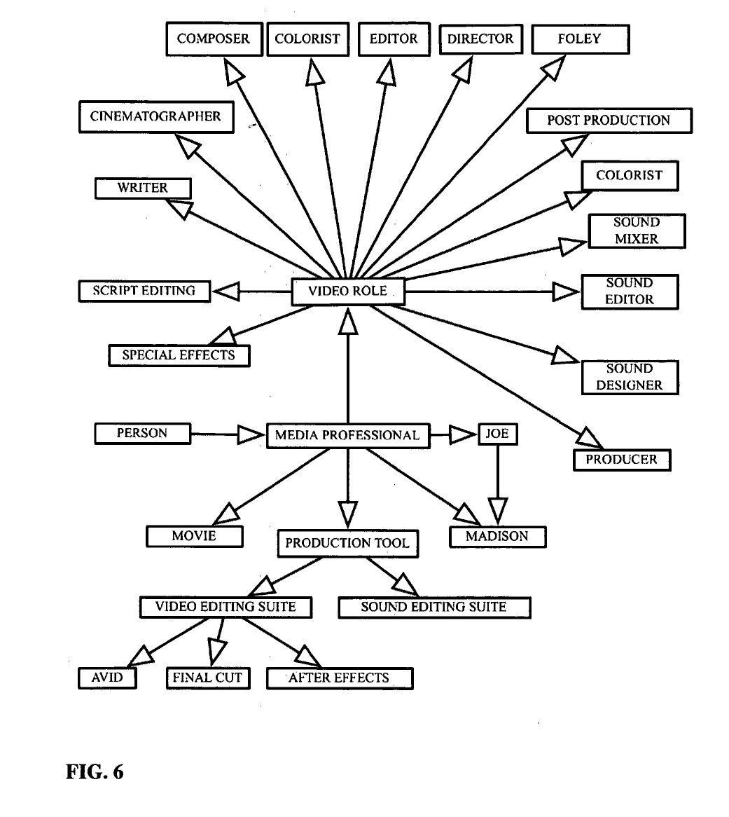

The principle processes of project team creation are defined in FIG. 1-FIG. 3. A system administrator 200A provides core information sources and constructs templates required to describe the roles and capabilities that a register user (a team creator) of the system will use to define project team requirements. The team creator 211 in FIG. 2 can supplement the initial set of information sources 100 in FIG. 1. For example, a team creator could provide links to relevant online social networks. In general, information sources are the task-specific blogs, online community forums, social networks, member profiles, and film websites that directly describe the skills, work and interests of potential team members. Referring to FIG. 1, for each data source document 100 information extraction is performed by first separating the text into tokens 103 and then identifying the part of speech 104 of the extracted tokens. A Standard English grammar 101 and domain corpus 102 consisting of texts related to the task domain are used. These may be extended to other languages and other domains by using the appropriate grammar and domain corpus. Next, semantic content extraction 106 is used to identify complex concepts and events 107. These compound objects are found by specifying rules that match sequence of words to concepts, and sequences of identified concepts to yet more complex entities. Semantic content extraction is performed using an ontology 105 of concepts related to the particular domain. FIG. 6 is an ontology for film production, describing concepts such as movie director, editor, and sound designer. These concepts are instantiated when particular tokens are identified in the input stream (e.g. the token stream “the editor is Wendy” creates an instance of the FilmCredit concept with Wendy associated with the Editor role).

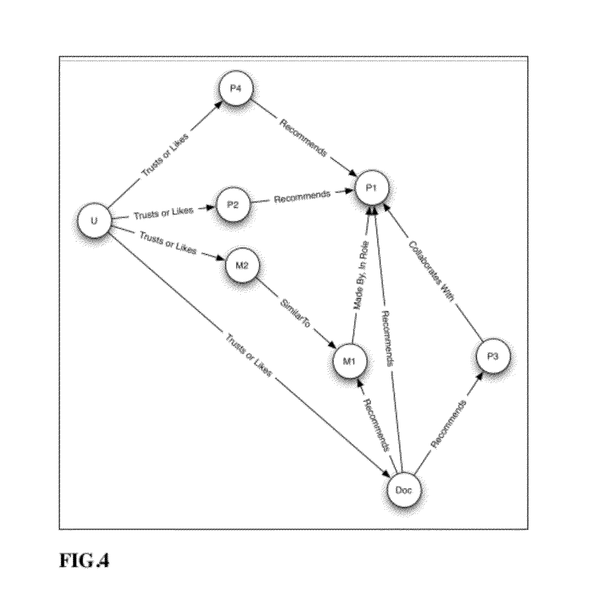

Sets of rules 108 are applied to the identified events and objects to identify relationships. For example, if Wendy worked as editor on Film1, and Steve worked as the director on Film1, then Steve and Wendy are Collaborators. The result of the information extraction 109 in FIG. 1 is a graph of relationships: collaborations, recommendations, and roles in a particular project. These relationships can be defined on a per-domain basis. For the example of film production, examples are illustrated in FIG. 4-FIG. 6.

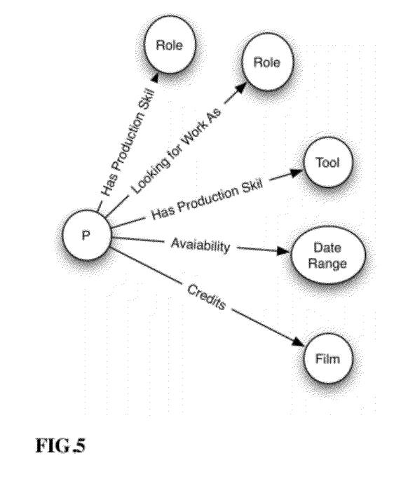

Having identified useful relationships between people, we are then able to use this information to construct a ranking of known persons with respect to particular characteristics that are suitable for inclusion in the desired project team. Among these would be inferred skill at a particular task based upon comments and reception of the work produced by the task. Taken together, these features can be weighted with respect to a team member characteristic of interest, and the recommendation made on that basis. Features that are important for computing a team member score for video production are shown in FIG. 4. A user U 400 may Like 401 (as in like the work of) another person (P4 402 in the graph of FIG. 5). For purposes of scoring, the object relationship in FIG. 4 Recommends 403 is transitive, allowing the fact that a user has recommended the work of another (P4 402 Recommends 403 P1 403) The relationship CollaboratedWith 417 can also be used to identify potential collaborators (P3 418 CollaboratedWith 417 P1 407). Documents (blogs, movie profile pages from Vimeo, etc.) can recommend a collaborator—for example a movie profile page can identify that a movie has a high number of likes, and that number of likes can factored into the rank of the individuals that were involved in the movie. FIG. 5 shows object properties that can be used to further filter the candidates. FIG. 6 is illustrative of the video production domain, showing the relationships in FIG. 4 and FIG. 5 along with particular instances of members.

A semantic network describing the capabilities of a potential team member can therefore be extracted from one of the Internet information sources enumerated in paragraph. FIG. 2 depicts the process through which multiple capability graphs 206, 207 are merged 208 209 to produce a consolidated semantic network describing the complete span of the knowledge of the team builder of possible team members. The means of ranking persons represented in the combined semantic network graph with respect to some task 212 213 is provided by four algorithms presented below.

The simplest algorithm for team assembly is called SimpleRetriever. Each user profile as a bag of words (Lewis, 1998) with the desired capabilities of the Team Member are used as query terms. The bag of words can be constructed from a plain text profile by stemming. We developed an ontology driven parser using latent semantic indexing for term extraction, and used information retrieval methods term frequency inverse document frequency to created member indexes.

The method maintains a semantic network for each significant task skill (e.g. Cinematography), where the edges will correspond to the relations, and vertices correspond to either individuals (community members) in the community or to documents (including profiles, movie tags, movie ratings, threaded discussions, video, video metadata, and blogs). We refer to the respective semantic subgraphs as Community Capability Graphs (CCG). For each CCG, we calculate the weighted rank of team member vertices, where some relations (Trusts or Likes 404) contribute just a binary (0 or 1) weight, while others (RecommendForWork 403) may have integer weights that are assigned on a scale. On each of the subgraphs, the summed weighted rank of a vertex corresponding to a community member determines the scoring of the community member as a potential team member. For each of the relation graphs we determine the nodes of weight at least w. These vertices are stored in a priority queue.

In FIG. 5 each Role 502, 503 within a team will map to a set of propositions on the set of relations. For the movie production domain, an acceptable Editor is listed as an editor in some E number of movies, and the genre of the movie match the criteria specified by the team creator. As new edges and vertices are added to the system, propositions can be run on those added links so that the subgraphs can be annotated appropriately. Important constraints include the availability 506, the interval over which a team member must be able to work, rate 510, which is the hourly rate of the perspective team member.

A satisfying assignment will be determined by picking an element from each sorted queue that matches the constraints associated with each of the respective Roles. The problem general problem of assigning individuals to roles in a team with constraints on cost can be reduced to computing a perfect match between the graphs V and T, where V=vertices in the union of all community graphs corresponding to the candidate team members, E=number of edges corresponding to each measure of quality that is considered for assignment (the rate, the strength of recommendation, the preferred years of experience), and T=size of the team. In FIG. 2, this step is shown at 213. Determining a perfect match between the two graphs where all candidate team members are selected from union of all community capability graphs is bounded by O(V̂2*log(V)+V*E) using Djikstra's algorithm (Fredman 1987). By categorizing the candidate team members by role and keeping a priority queue for each role class, it is possible to reduce the running time to log linear in V. That is, if each potential team member is separable by job description, then finding a matching becomes retrieving from each respective priority queue (cost of logy) T times. By filtering the set of V using the criteria supplied by the team creator to sets of size T, we can then iterate over samplings from the larger V. There will be cases where a potential team member may possess the skills required by a number of roles, in which case the quadratic search would have to be used to determine the best team. Because the list of candidates is filtered the number of vertices required for matching is closer to T rather than the complete set, the running time of candidate selection is bounded by O(T̂2*log(T)+T*E). It is also possible to compute perfect matching in N*(T*logT) using Monte Carlo methods (Goel 2010) where N is the number of iterations performed in selecting and filtering teams of sized T.

There are several heuristics than can be applied to reduce the search space. Another algorithm developed is called BestReferrableTeam. For each subgraph identified in BestTeamLookup, we take a Friend graph, which is the set of contacts (vertices). For each Friend, determine via breadth first search if there exists a path of length <k to the nodes defining the Relations. Remove any nodes in the set for which there is no path <k. The complexity of this operation is O(V): its running time will be less than single-source shortest path where the source is the user node and the expert nodes for each of the CCGs.

The next algorithm that we provide is called BestKnownTeam. Having identified the community's best team given the search criteria, we can define a metric for identifying the person in the team creator's set of social network contacts (out to weak ties) which best approximate the capabilities of the larger community's experts. We add each member of the expert groups identified by BestTeamLookup into the training set, and then construct a classifier LocalExpertFinder based on attributes of the community expert. This LocalExpertFinder is inferred through used of the ID3 decision tree learning algorithm.

We can separate the information about expertise into two sources: meta-information and content. Verbal reports of experiences working with an individual provide an important measure of reliability and work ethic. This is a kind of meta-information about work patterns. The other factor is content—how similar is the style and esthetic of the community expert to the weak ties of the team creator. Comments and scoring provide a method of filtering the set for human analysis of the suitability of content for a particular production task.

The task of determining assignment based on content filtering can be accomplished using collaborative filtering algorithms. Since our communities are likely to have tagged content, we begin with an approach based upon tag-based movie recommendation described by (Sen, Vig, & Riedl, 2009). A tag-based recommender is computed as a linear combination of tags associated with expert movies

$$R ( u , m ) = {\sum }_{i = 1}^{tags} {h}_{i}^{*} ntp ( u , {tag}_{i} )$$

In this equation, each movie m has associated with it a set of tags. The ntp is determined by scoring how frequently tagᵢ is used to describe movies that they favor. This ntp can be determined from constructing a histogram of tags from the supplied documents. Once each hᵢ is determined based on expert ranking, then the same recommender is applied to determine the most appropriate recommendation from weak ties.

After the user is presented with the list of candidate teams, they can refine the constraints to arrive at an appropriate team. After the final team is selected, team members can then be contacted, and contracts negotiated with the individual members. The team creator can then create a project web page on which to collaborate with the selected team members.

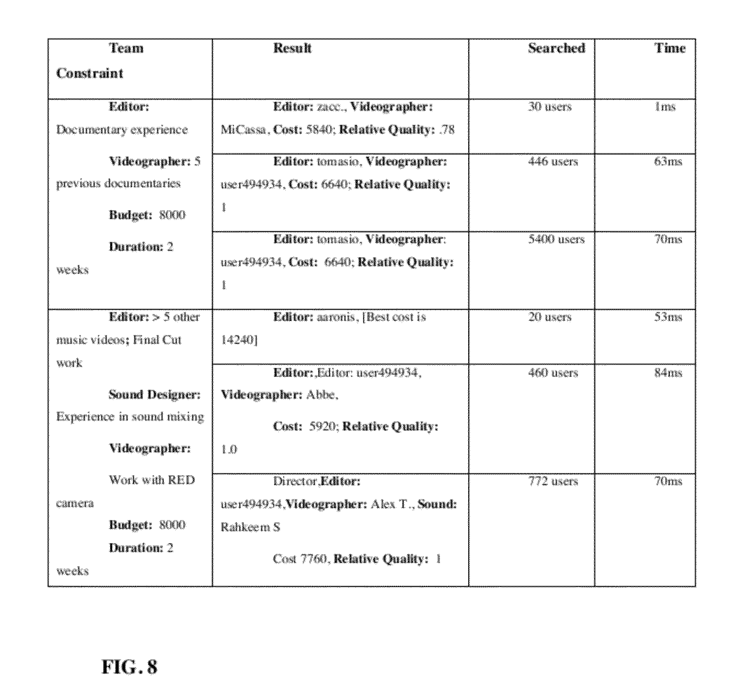

The automated team construction method is initially provided with requirements and constraints that specify the characteristics of the team a team creator wishes to assemble. FIG. 8 shows example requests for team construction that were run against a semantic network built from profiles on the Vimeo video sharing web site. The first request is for staff to support a documentary, the second a music video. Users will specify team constraints with intuitive visual interfaces, and the recommendations would be returned on a gallery page on the web site showing thumbnails and contact of the recommended team. Candidate team suggestions are returned with the associated cost given a duration provided by the user; we show the associated user name of the highest-rated candidates. We show the running time and graph size (the number of Vimeo user profiles considered during planning). The cost is more or less constant, having more to do with how well the price and skills are covered by the selection set. In these examples, the best-rated team at or below cost is chosen. The results are somewhat intuitive in that the more users there are to consider, the more options that there are in terms of skill. In the first music video example, the limited set does not include any one listing videography skills. Moving forward, we will explore more complex matching and recommendation.

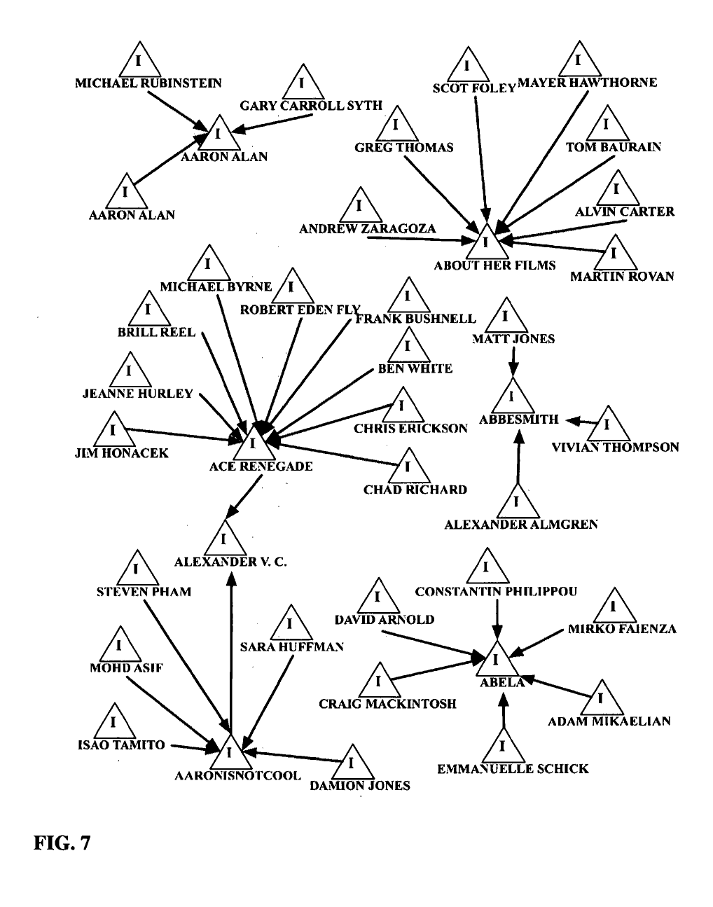

Currently the score assigned a team is determined by how well their work is liked and by their centrality in the CCG. In FIG. 8, the relative quality is the quotient of the member's score and the highest for the particular role. Natural extensions to the score include the recommendation provided by friends, and the reported reliability of the person, or inferences about how well the members are likely to work together. We are exploring how image feature analysis could be used to extend the way in which users can describe team member attributes (e.g. cinematographer that does nature photography). As we proceed to launching the collaboration website we will continue to evaluate and improve the algorithms. Processing for each of the algorithms presented involves a data collection phase in which information is retrieved from information sources; an analysis phase in which the semantic relations are computed for each of the CCGs; and a construction phase in which team assignments are computed. We collected over 1500 user profiles (each profile references 5 collaborators on average, most external to Vimeo) and over 10000 movie profiles from Vimeo as a test set. A subgraph showing collaboration relationships for a group of 6 filmmakers with each filmmaker having identified 10 collaborators is shown in FIG. 7. Both the crawl and analysis are offline processes, and a complete analysis to support planning requires on average 0.5 second per user on a commodity desktop computer—this includes natural language information extraction (the largest bottleneck) of credits and styles from each movie, individual profile, and discussion thread. Based on analysis of the Internet Movie Database website (IMDB), we expect that film collaborator networks will have similar structure. If we increase this factor by 10 to account for analysis of personal network information (other community sites, blogs) then the analysis required to support the automated team construction process—we estimate a professional user base of 10000 is required to support the commercial marketplace concept—can be readily accomplished on cloud hardware, for example using a cluster of Amazon minimal EC2 instances would suffice for providing daily update of the semantic network used by the automated team construction method.

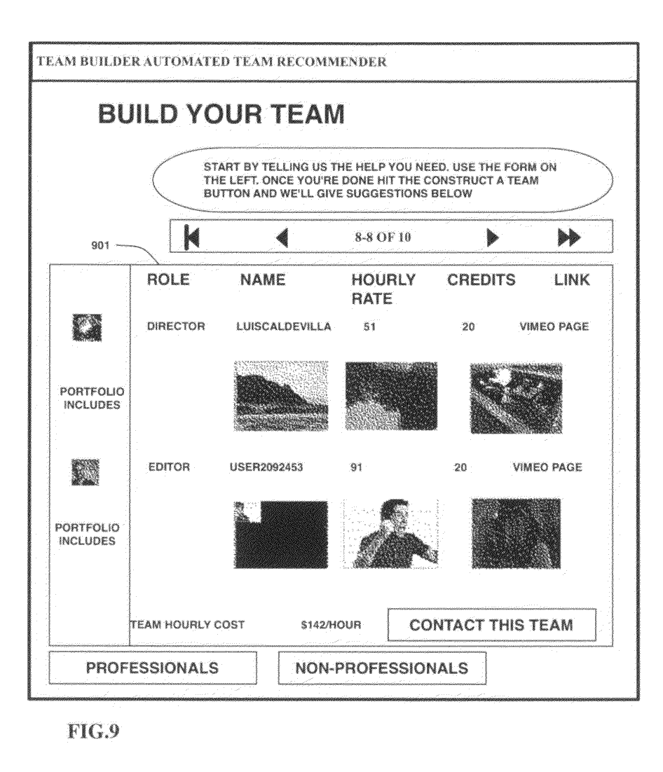

After the recommended teams are constructed the team creator can then adjust them as they see fit. A graphical interface that provides input to the team construction method is depicted in FIG. 9 with display 901 of the team recommendations produced. The team creator can then contact members of the team and execute contracts for each of the team members to cover their duration of work. We then generate a basic website that can be used to track the progress of the work and facilitate communication between members of the team. This also includes the capability to store rough cuts of video online.

### CONCLUSIONS, RAMIFICATIONS AND SCOPE

The described method for automated construction of project teams is able to produce team recommendations in time that scales well with the size of the input graph. As the size of online information sources grows, the automated team construction application will be an important capability to support the rapid creation of work teams. Further, the pervasiveness of social networks means that the usefulness of the team construction platform will only increase.

Identifying compatible team members could take a number of approaches. Heuristics for how people will work together, deeper ways of evaluating the kinds of work that someone has in their portfolio against the work requirements, as well as assessment of the work style can be incorporated into the platform in a modular way. The social network analysis could also be used to resolve the attribution of work problem: that is resolving what the particular contribution of an individual to a project was.

I claim:

1. A method for identifying and assembling a project team, consisting of one or more workers, to accomplish a given task in response to a request from a requester to assemble a team to perform said work comprising:
a. providing an input means through which said requester provides a specification of the said project team,
b. storing the specification for said project team in a database on a server,
c. retrieving information from databases and other Internet information sources containing data relating to potential project team members,
d. providing a data analysis means through which said data relating to potential team members is used to produce a ranking of said potential project team members for roles in the said project team,
e. providing a sorting means through which candidate project teams are selected based upon said data analysis means,
f. providing a display means for presenting team candidates to the requester,
g. providing an input means through which the requester selects presented candidate teams,
h. providing a communication means through which the requester contacts members of the said team,
i. providing a website through which the requester and the members of the selected team are able to conduct the work for which the team was assembled.

2. The method recited in claim 1 wherein the input means consists of a webpage.

3. The method recited in claim 1 wherein the specification includes at least one or more of the following information: duration of the said task which said team is being assembled to perform, a list describing desired roles to be assigned each member of said team during performance of said task, a list of desired skills possessed by each member of said team, a list describing the rate of pay desired for each member of said team, a list describing one or more on-line social networks of which said requestor is a member, a list describing one or more on-line discussion forums of which said requestor is a member, a list of web sites including blogs that the requestor likes, and a list of one or more personal profiles of potential team members.

4. The method recited in claim 1 wherein the step of retrieving information consists of web crawling information sources provided by said requester including: on-line social networks, discussion forums, blogs relating to the skills comprising the task, web sites relating to the task, micro-blogging services relating to the task, and transferring other data sources provided by the requester to the database server described in claim 1.

5. A method for constructing a semantic network describing the skills of a group of people for performing a task comprising:
a. providing a semantic network which contains nodes corresponding to each person in said group,
b. providing a set of semantic relationships for describing prior work, rating the prior work, describing the people that a person has worked with, describing the aesthetics of prior work performed by a person in said group,
c. providing a set of semantic relationships for describing the salary requirements of a person within said group,
d. providing a set of semantic relationships for describing the availability of a person within said group for work,
e. providing a set of keywords and phrases associated with the semantic relationships in steps a through d,
f. providing a text processing means for mapping a text information source to a semantic network representation in said semantic network,
g. providing a data transformation means for mapping a structured information source from a relational database to a semantic network representation store in the said semantic network.

6. The method recited in claim 1 wherein the step of text processing consists of: a tokenization step that determines tokens for the words in a text, a part of speech tagging step that associates tokens with part of speech, a semantic concept recognition step wherein tokens and sequences of tokens are matched to keywords and tokens described in claim 5, and a semantic network storage step in which matched semantic concepts are instantiated in the semantic network mentioned in claim 5.

7. The method recited in claim 5 wherein the step of mapping from a structured data base consists of: retrieving a collection of rules consisting of patterns and actions where actions specify concepts to add to the semantic network and patterns are used to identify information contained in the structured data base, matching the aforementioned patterns against entries in the database, and entries are made in the semantic network as prescribed by the actions of the rules for which the pattern component matched an entry in the database.

8. A method for ranking a person with respect to their suitability to perform a task comprising:
a. providing a semantic network in which a node corresponds to said person,
b. providing a set of descriptive nodes in said semantic network that represent:
i. descriptions of the prior work performed by said person,
ii. reviews of the prior work of the said person,
iii. descriptions of the aesthetic elements of the prior work of said person,
iv. references for said person with respect to their ability to perform a said task,
v. descriptions of the time and date intervals during which the said person is available to work on said task,
vi. formal and informal transcripts of interviews provided by that individual,
c. providing a set of links in said semantic network between the node representing said person said descriptive nodes relating to them,
d. providing a node analysis means for scoring the links between nodes in said semantic network where one node represents the individual and the second node represents an aforementioned descriptive node,
e. providing a categorization function as a means for grouping all outgoing links from any node in said semantic network representing an individual according to the said task,
f. providing a semantic graph function as a means for determining said suitability which takes as input a given task, an individual, retrieves all links determined by said categorization function and returns a score based upon said links indicating the appropriateness of the individual for said task.

9. The method recited in claim 8 in which the roles and skills represented in the semantic network as nodes are initially entered by a system administrator using a text editor means to enter node descriptions.

10. The method recited in claim 8 in which the roles and skills represented in the semantic network as nodes are initially entered by a system administrator using a graphical editor means to enter node descriptions.

11. The method recited in claim 1 in which the step of producing a ranking of said potential team members for roles in the said team consists of: scoring each node corresponding to a person in said semantic network using the method recited in claim 8 and then sorting the scored nodes by score.

12. The method recited in claim 1 in which the step of providing communication between the requester and the team consists of an automated construction of a webpage to facilitate communication between members of the selected team and the requester of the team.

13. The methods recited in claim 1 providing a means through which the person seeking to retain the services of the team can monitor their progress toward identified goals.

14. The method of claim 1 whereby the interface of the server described in claim 1 provides a html form interface allowing a person wishing to join a team constructed by the method of claim 1 is able to search for teams constructed to join based upon their requirements for salary, their work history, and their prior work.

15. The method of claim 1 whereby the task described in claim 1 involves post-production of video content involving the editing, sound design, special effects production, and color matching of video, audio, graphical content, and other material to be used in production of a final video product.

16. The method of claim 1 in which the task described in claim 1 involves the development of software and the disparate information sources in claim 1 include one or more publicly accessible web sites on which is contained a database of publicly accessible computer software for a given software system, information for the developers of that software system is provided, the revision history of the software product is provided, comments between the developers of the software system is provided.
